(19) United States
(12) Patent Application Publication
(10) Pub. No.: US 2016/0341473 A1
(43) Pub. Date: Nov. 24, 2016

(54) AIR RECYCLING VENTILATION ASSEMBLY FOR INFRARED RADIATION EMITTER WITH TEMPERATURE CONTROL

(71) Applicant: SUNKISS MATHERM RADIATION, Bressolles (FR)

(72) Inventor: Michel CHARMES, Bressolles (FR)

(73) Assignee: SUNKISS MATHERM RADIATION, Bressolles (FR)

(21) Appl. No.: 15/112,341

(22) PCT Filed: Jan. 14, 2015
(86) PCT No.: PCT/FR2015/050086

§ 371 Date: Jul. 18, 2016

(30) Foreign Application Priority Data
Jan. 16, 2014 (FR) 1450344

(51) Int. Cl. F26B 3/28; F26B 21/04; F26B 21/00; F26B 3/30; B05C 9/14

(52) U.S. Cl. CPC F26B 3/283; F26B 3/30; B05C 9/14; F26B 21/001; F26B 21/04

(57) ABSTRACT

An assembly including at least one furnace including at least one infrared radiation emitter, the furnace including an air inlet and an air outlet, wherein the assembly also includes a ventilation casing including a main air inlet and a main air outlet, the air inlet of the furnace and the air outlet of the furnace cooperating with the main air outlet of the ventilation casing and the main air inlet of the ventilation casing respectively, the ventilation casing being designed to supply air to the furnace.

The invention concerns the field of the ventilation of the furnaces including infrared radiation emitters.

Some furnaces or ovens intended for the drying, the fusion or the polymerization of paints, adhesives or the like, are equipped with at least one infrared radiation emitter comprising at least one catalytic cell. An example of infrared radiation emitter called thermoreactor is described in EP0754911A1.

These furnaces are also equipped with motor-fan unit allowing bringing the air to these infrared radiation emitters. Generally each infrared radiation emitter is associated with a motor-fan unit. However, this air supply system is costly and cumbersome. Indeed, a furnace may comprise for example a hundred infrared radiation emitters, each associated with a motor-fan unit, which is costly and increases the volume of the furnace substantially.

Furthermore, the air heated by the infrared radiation emitters is then evacuated via an air extraction of the furnace and the air coming from outside, therefore colder than the inside of the furnace, is brought into replacement, which leads to significant energy losses.

The invention aims to remedy all or part of the aforementioned drawbacks.

The object of the invention is an assembly comprising at least one furnace including at least one infrared radiation emitter, the furnace including an air inlet and an air outlet, characterized in that the assembly further comprises a ventilation chamber including a main air inlet and a main air outlet, the air inlet of the furnace and the air outlet of the furnace cooperating respectively with the main air outlet of the ventilation chamber and the main air inlet of the ventilation chamber, said ventilation and recycling chamber being designed to carry out an air circulation in the furnace.

Thus, the assembly of the infrared radiation emitters are supplied with air by a single ventilation chamber which cooperates with the air inlet and outlet of the furnace, which allows having a less cumbersome and less expensive assembly. Furthermore, as the air management is performed by a single chamber, the energy losses are avoided and the temperature is regulated. Furthermore, the chamber thus arranged relative to the furnace allows recycling the assembly of the air flow coming from the furnace and reinjecting it into said furnace. Thus, the air taken in the furnace being increasingly hot, less and less gas is used to reach the setpoint temperature of the furnace when starting.

Advantageously, the assembly allows keeping a constant temperature in the furnace when the latter is associated with a regulation of the emitters of infrared radiation.

According to one characteristic of the invention, the ventilation chamber comprises a main conduit linking the main air inlet and the main air outlet, the main conduit comprising at least one main air flow regulation register. Preferably, the main register comprises a plurality of flaps.

According to another characteristic of the invention, the ventilation chamber comprises a secondary air inlet called outside air inlet and/or a secondary air outlet called recycled air outlet, said secondary air inlet and/or said secondary air outlet opening into the main conduit.

According to another characteristic of the invention, the secondary air inlet is set by means of at least one secondary air flow regulation register and/or the secondary air outlet is set by means of the least one secondary air flow regulation register.

According to another characteristic of the invention, each secondary register and/or the main register are driven by a control device, each secondary register and/or the main register being shaped to be positioned in at least one position called recycling position in which the main register is open and each secondary register is closed. Thanks to this recycling position, the temperature rise time is accelerated relative to a non-equipped traditional furnace of the chamber according to the invention. Furthermore, the unburned fumes and volatile organic compounds are burned when they are reinjected into the or each infrared radiation emitter.

Preferably, the main register and the secondary register are driven by a servomotor, depending on the temperature of the furnace and a setpoint which are transmitted to the servomotor.

According to the invention, the assembly comprises at least one temperature measuring member, for example a probe, which is positioned in the furnace or in a ventilation circuit of the furnace, said measuring member being controlled by a regulator. The temperature setpoint is set by the regulator which drives the servomotor and the driven registers. If the temperature measured in the furnace via the probe is lower than the setpoint, the chamber operates in the recycling position. If the measured temperature is greater than the setpoint, the chamber operates with a fresh air supply and the main register is closed. Preferably, the servomotor depends on the temperature probe.

According to another characteristic of the invention, each secondary register and/or the main register are shaped to be positioned in at least one position called intermediate position in which the main register is partially open and each secondary register is partially open. This intermediate position allows the mixing of the recycled air with the incoming air coming from the outside which allows the regulation of the temperature through an opening and a proportional closing of the registers according to the required air temperature.

According to another characteristic of the invention, each secondary register and/or the main register are shaped to be positioned in at least one position called extraction position in which the main register is closed and each secondary register is open. In this position, the air is not recycled, the fumes and the hot air are evacuated and cold outside air is injected into the furnace. This position is recommended to cool the furnace.

According to another characteristic of the invention, each secondary register and the main register are simultaneously driven. Preferably, a connecting rod system allows the movement simultaneously. According to another characteristic of the invention, the ventilation chamber comprises at least one filter positioned upstream of the main air outlet of the ventilation chamber or upstream of the air inlet of the furnace.

According to another characteristic, the ventilation chamber is equipped with at least one fan close to the main air inlet. Thus, the fan positioned close to the air inlet of the furnace brings the air of the furnace into the ventilation chamber.

According to another characteristic, the ventilation chamber is equipped with at least another fan positioned close to the main air outlet. Thus, the fan positioned close to the main air outlet of the ventilation chamber brings the air flowing in the ventilation chamber into the furnace.

The invention will be better understood thanks to the following description, which relates to an embodiment according to the present invention, given by way of non-limiting example and explained with reference to the appended schematic drawings, in which:

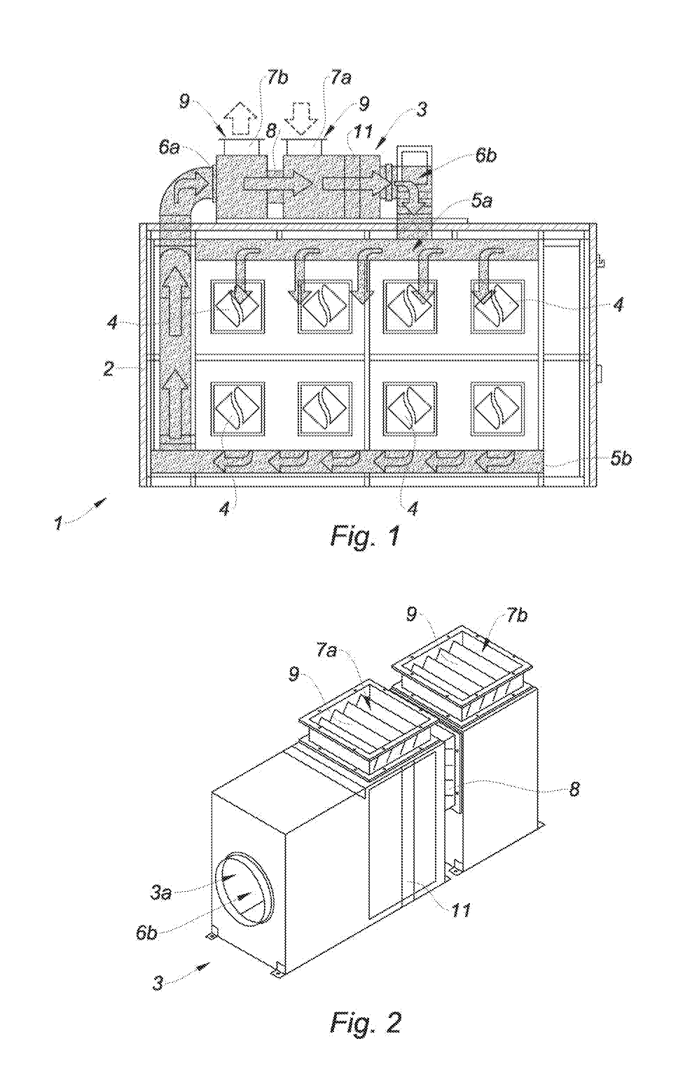

FIG. 1 shows a schematic sectional view of the assembly according to the invention,

FIG. 2 shows a schematic perspective view of the ventilation chamber of the assembly shown in FIG. 1,

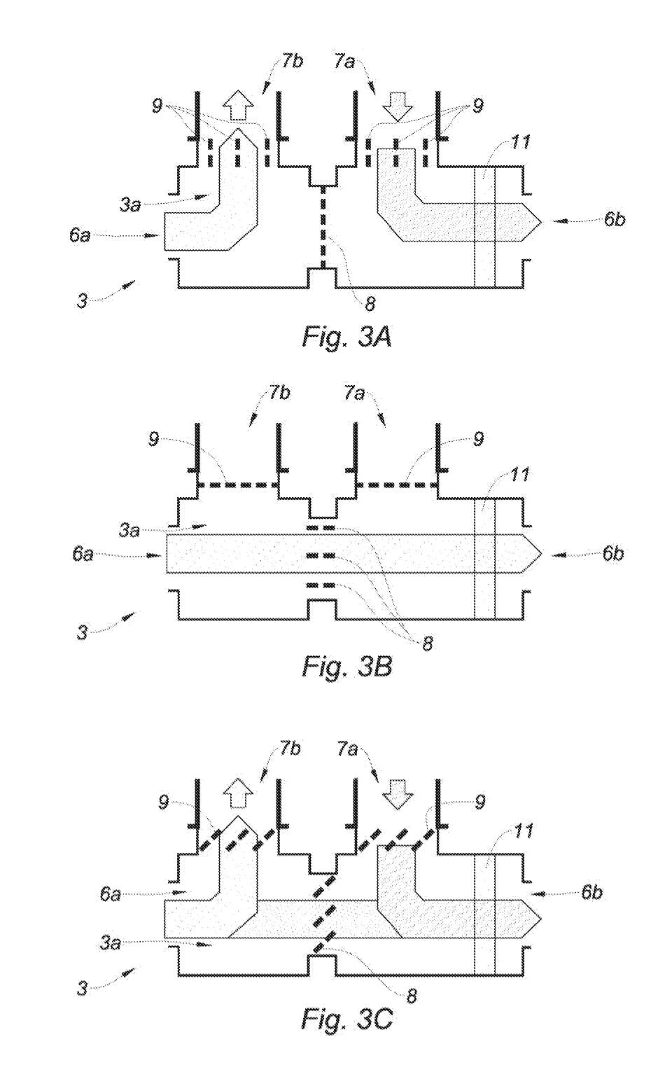

FIG. 3A represents a first operating configuration of the chamber shown in FIG. 2,

FIG. 3B shows a second operating configuration of the chamber shown in FIG. 2, and,

FIG. 3C shows a third operating configuration of the chamber shown in FIG. 2.

The assembly 1 according to the invention is shown in FIG. 1 and comprises a furnace 2 including a plurality of emitters of infrared radiation 4 and a ventilation chamber 3.

As it may be seen in FIG. 1, the furnace 2 comprises an air inlet 5a and an air outlet 5b. Furthermore, the ventilation chamber 3 comprises a main air inlet 6a and a main air outlet 6b.

According to the invention, the air inlet 5a of the furnace 2 cooperates with the main air outlet 6b of the ventilation chamber 3. Similarly, the air outlet 5b of the furnace 2 cooperates with the main air inlet 6a of the ventilation chamber 3. Thus, the air present in the furnace 2 flows into the ventilation chamber 3 before being reinjected into the furnace 2. In order to bring the air into the ventilation chamber 3, the furnace 2 comprises at least one fan (not shown) positioned close to the air outlet 5b of the furnace 2. In order to reinject the air flowing in the ventilation chamber 3 into the furnace 2, the furnace 2 comprises at least another fan (not shown) positioned close to the air inlet 5a of the furnace 2.

As illustrated in FIGS. 1 and 3A, 3B and 3C, the ventilation chamber 3 comprises a main conduit 3a. The main conduit 3a extends along the longitudinal axis of the ventilation chamber 3 and opens on opposite lateral faces of the ventilation chamber 3. The main conduit 3a comprises at an open end, the main air inlet 6a of the ventilation chamber 3 and at the other of the open ends, the main air outlet 6b of the ventilation chamber 3.

In the example illustrated in FIGS. 1 to 3C, the main conduit 3a comprises a narrowed median section in which a main register 8 comprising air regulation flaps is positioned. According to the invention, the main register 8 can be placed anywhere in the main conduit 3a as long as it meets the condition according to which the main register 8, when it is in the closing position, said main register 8 completely blocks the main conduit 3a.

In FIGS. 1 to 3C, the ventilation chamber 3 comprises a secondary air inlet 7a which brings the air coming from outside of the furnace 2 and a secondary air outlet 7b which allows extracting air outwards. As illustrated, the secondary air inlet 7a and the secondary air outlet 7b open into the main conduit 3a. The secondary air inlet 7a and the secondary air outlet 7b extend substantially perpendicularly to the main conduit 3a. The secondary air inlet 7a and the secondary air outlet 7b are positioned on both sides of the narrowed section of the main conduit 3a. Furthermore, the secondary air inlet 7a and the secondary air outlet 7b each comprise a secondary air flow regulation register 9, each secondary air flow regulation register 9 including, as in the shown example, air regulation flaps.

In FIG. 1, the ventilation chamber 3 is disposed on the furnace 2 and is connected to the furnace 2 by means of flexible type connections or air pipes. Of course, the position of the ventilation chamber 3 relative to the furnace 2 is not limited to this example.

As it may be seen in FIGS. 1 to 3C, the chamber comprises a filter 11 disposed upstream of the main air outlet 6b. This filter may be of the particulate filter type, for example.

FIGS. 3A to 3C illustrate possible operating configurations of the ventilation chamber 3.

In FIG. 3A, the chamber is in a position called extraction position. The air flow coming from the furnace 2 is brought into the ventilation chamber 3 through the main air inlet 6a, passes through a portion of the main conduit 3a and is conducted towards the secondary air outlet 7b. In this configuration, the totality of the air flow coming from the furnace 2 is extracted as the main register 8 is completely closed and the secondary register 9 placed in the secondary air outlet conduit 7b is completely open. Furthermore, as the air of the furnace 2 is completely extracted, we must renew this air from the outside air. The outside air enters the ventilation chamber 3 via the secondary air inlet 7a crosses a portion of the main conduit 3a, is filtered by means of a filter 11 disposed close to the main air outlet and 6b then is injected into the furnace 2. In this configuration, the secondary register 9 placed in the secondary air inlet 7a is completely open and as previously said the main register 8 is completely closed in order to prevent the mixing between the air of the furnace 2 intended to be extracted and the outside air intended to be injected into the furnace 2.

In FIG. 3B, the ventilation chamber 3 is in a position called recycling position. In this recycling configuration, the air flow coming from the furnace 2 is brought into the ventilation chamber 3 via the main air inlet 6a, passes through the main conduit 3a, is filtered and then evacuated via the main air outlet 6b in order to be reinjected into the furnace 2. In this configuration, the secondary registers 9 positioned in the secondary air inlet 7a and in the secondary air outlet 7b are closed and the main register 8 is open.

In FIG. 3C, the chamber is in a position called intermediate position. In this configuration, the secondary registers 9 positioned in the secondary air inlet 7a and in the secondary air outlet 7b are partially open and the main register 8 is also partially open. The air flow coming from the furnace 2 is brought into the ventilation chamber 3 through the main air inlet 6a, a portion of the air flow is then extracted via the secondary air outlet 7b and a portion of the air flow passes through the main conduit 3a. At the secondary air inlet 7a of the outside air is brought into the main conduit 3a in order to be mixed with the air flow passing through the main conduit 3a and coming from the furnace 2. The air mixture or mixing takes place in the main conduit 3a upstream of the main air outlet 6b and the filter 11. The mixed air is then filtered then reinjected into the furnace 2. Of course, the configurations shown in FIGS. 3A to 3C are only examples and the ventilation chamber 3 has a plurality of other possible intermediate configurations.

As seen in FIG. 1, the air flow is reinjected into the furnace 2 by several air distribution channels disposed along the furnace in the upper portion of the furnace 2. Furthermore, the air outlet 5b of the furnace 2 is disposed in the lower portion of the furnace 2, the air flow coming from the furnace 2 runs along the lower wall of the furnace 2 then is conducted in an air outlet conduit 5b disposed substantially laterally to a lateral wall of the furnace 2. Of course, the routing and the distribution of the air flow within the furnace 2 is not limited to the illustrated example.

Of course, the invention is not limited to the embodiment and operating configurations described and represented in the appended figures. Modifications are possible, in particular from the point of view of the constitution of the various elements or by substitution of technical equivalents, without departing from the field of the protection of the invention.

1. An assembly comprising at least one furnace including at least one infrared radiation emitter, the furnace including an air inlet and an air outlet, wherein the assembly further comprises a ventilation chamber including a main air inlet and a main air outlet, the air inlet of the furnace and the air outlet of the furnace cooperating respectively with the main air outlet of the ventilation chamber and the main air inlet of the ventilation chamber, said ventilation chamber being designed to carry out an air circulation in the furnace and in that the assembly comprises at least one temperature measuring member that is positioned in the furnace or in a ventilation circuit of the furnace, said measuring member being controlled by a regulator.

2. The assembly according to claim 1, wherein the ventilation chamber comprises a main conduit connecting the main air inlet and the main air outlet, the main conduit comprising at least one main regulation register of air flow.

3. The assembly according to claim 2, wherein the ventilation chamber comprises a secondary air inlet called outer air inlet and/or a secondary air outlet called recycled air outlet, said a secondary air inlet and/or said secondary air outlet open into the main conduit.

4. The assembly according to claim 3, wherein the secondary air inlet is set by means of at least one secondary air flow regulation register and/or the secondary air outlet is set by means of at least one secondary air flow regulation register.

5. The assembly according to claim 4, wherein each secondary register and/or the main register are driven by a control device, each secondary register and/or the main register being shaped to be positioned in at least one position called recycling position in which the main register is open and each secondary register is closed.

6. The assembly according to claim 5, wherein each secondary register and/or the main register are shaped to be positioned in at least one position called intermediate position in which the main register is partially open and each secondary register is partially open.

7. The assembly according to claim 5, wherein each secondary register and/or the main register are shaped to be positioned in at least one position called extraction position in which the main register is closed and each secondary register is open.

8. The assembly according to claim 5, wherein each secondary register and the main register are driven simultaneously.

9. The assembly according to claim 1, wherein the ventilation chamber comprises at least one filter positioned upstream of the main air outlet of the ventilation chamber or upstream of the air inlet of the furnace.
